(19) United States
(12) Patent Application Publication
(10) Pub. No.: US 2009/0087823 A1
(43) Pub. Date: Apr. 2, 2009

(54) Monetary skills game

(76) Inventor: Ernestine Tucker, Rahway, NJ (US)

Correspondence Address: Jim Montgomery, 8th Floor, 5201 Blue Lagoon Drive, Miami, FL, 33126, US

(21) Appl. No.: 11/986,062

(22) Filed: Nov. 19, 2007

Related U.S. Application Data
(60) Provisional application No. 60/976,478, filed on Oct. 1, 2007.

(51) Int. Cl. G09B 5/02

(52) U.S. Cl. 434/201

(57) ABSTRACT

An apparatus for a monetary skills game is presented. The apparatus includes a display for presenting animation and video of different coins and bills and their respective values to a child. The display further presents questions, having a monetary theme, to the child for teaching monetary information and skills to the child. A keypad is provided by which the child responds to the questions where, when the child properly responds to the questions, the child earns money in a pretend bank, accumulating interest at a set interest rate. The child may choose to spend the money by purchasing simulated items presented on the display. The child thereby learns the respective value of coins and bills, as well as saving and spending concepts, enabling parents of the child to encourage their child to learn financial responsibility.

### CROSS-REFERENCE TO RELATED APPLICATIONS

The present Utility patent application claims priority benefit of the U.S. provisional application for patent serial number 60976478 filed on Oct. 1st, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to games. More particularly, the invention relates to a game meant to teach monetary skills.

### BACKGROUND OF THE INVENTION

Games are often used to teach and entertain simultaneously. Educational games are available to teach a wide variety of subjects, for example without limitation, geography, history, mathematics, etc. A game with a monetary theme would be able to teach children information and skills concerning money including, but not limited to, the value of coins and bills and saving and spending concepts. A game with a monetary theme would also enable parents to encourage their children to learn financial responsibility at an early age.

In view of the foregoing, there is a need for improved techniques for teaching monetary information and skills with a game.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a front view of an exemplary handheld game console for teaching monetary information and skills, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a monetary skills game is presented.

In one embodiment, an apparatus for a monetary skills game is presented. The apparatus includes a display for presenting animation and video of different coins and bills and their respective values to a child, the display further presenting questions having a monetary theme to the child for teaching monetary information and skills to the child. A keypad is provided by which the child responds to the questions where, when the child properly responds to the questions, the child earns money in a pretend bank, accumulating interest at a set interest rate, where the child may choose to spend the money by purchasing simulated items presented on the display, whereby, the child can learn the respective value of coins and bills, as well as saving and spending concepts, enabling parents of the child to encourage their child to learn financial responsibility. In another embodiment, the apparatus further includes a pen slot for holding a pen for use by the child playing the monetary skills game. In other embodiments the display and keypad are configured for a hand held device and the display is a LCD type display. In still other embodiments, the keypad includes triangular shaped and rectangular shaped keys for ease of use by the child and the triangular shaped buttons are arranged in a pattern to indicate directionality. In further embodiments the apparatus is provided in one of a variety of exterior colors with consumer appeal, is adapted to operate on battery power, is adapted to operate with touch-screen capabilities, and the apparatus is adapted to operate with an audio system. In another embodiment, if the child spends all of the money in the bank, the monetary skills game presents further question on the display, such that the child may answer more questions correctly in order to earn more money. In yet another embodiment, when the child properly responds to the questions using the keypad, points are awarded, rather than money, with a goal of earning a highest amount points. In further embodiments, the questions include multiple-choice questions and the display presents various different levels or versions, of the questions, having different degrees of difficulty.

In another embodiment an apparatus for a monetary skills game is presented. The apparatus includes means for presenting animation and video of different coins and bills and their respective values to a child, the presenting means further presenting questions having a monetary theme to the child for teaching monetary information and skills to the child and means for the child to respond to the questions where, when the child properly responds to the questions, the child earns money in a pretend bank, accumulating interest at a set interest rate, where the child may choose to spend the money by purchasing simulated items presented on the display, whereby, the child can learn the respective value of coins and bills, as well as saving and spending concepts, enabling parents of the child to encourage their child to learn financial responsibility.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Embodiments of the present invention introduce monetary skills to children in the form of a game. The preferred embodiment is a handheld game console on which a game that teaches monetary information and skills may be played.

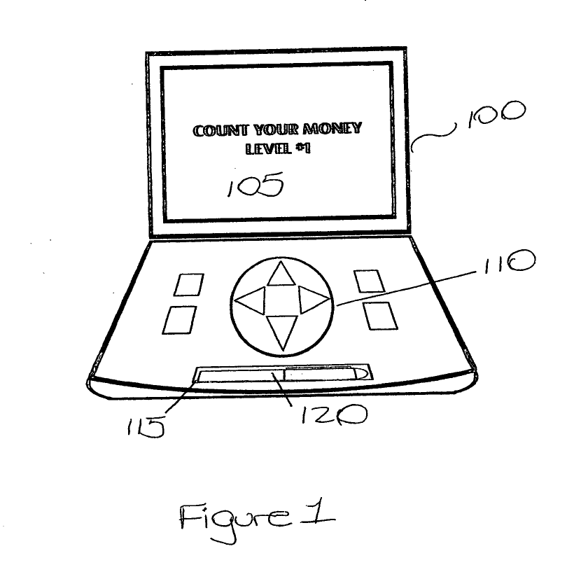

FIG. 1 is a front view of an exemplary handheld game console 100 for teaching monetary information and skills, in accordance with an embodiment of the present invention. In the present embodiment, game console 100 is portable and lightweight with a liquid crystal display (LCD) screen 105, a key pad 110, and a pen slot 115 with a pen 120 included. In the many applications of the present embodiment, pen 120 is useful to identify the answers on screen 105 and pen slot 115 is useful to rest pen 120. Alternate embodiments may not comprise a pen slot and pen. In the present embodiment, game console 100 is powered with a lithium-ion battery with the capability to power game console 100 for six to ten hours. Some embodiments may also comprise an electric charger with or without a car charger adaptor to recharge the battery. Alternate embodiments may be powered by various different means; for example, without limitation, some embodiments may plug into an electrical outlet or may be powered by different types of batteries such as, but not limited to, alkaline batteries. The dimensions of the present embodiment are approximately nine and three quarter inches wide by seven and a half inches long; however, alternate embodiments may be larger or smaller. Embodiments of the present invention may include various options such as, but not limited to, touch-screen capabilities, an audio system, and a variety of exterior colors with consumer appeal.

In the present embodiment, game console 100 enables children to learn monetary skills in an entertaining way. The game played on game console 100 introduces children to different coins and/or bills and their respective values using animation and video. In typical use of the present embodiment, a series of questions are presented to a child on LCD screen 105, and the child answers the questions using keypad 110. The questions asked by the game may be many different types of questions such as, but not limited to, multiple choice or fill in the blank, and typically concern monetary themes such as, but not limited to, the values of coins and bills, general knowledge about money, calculating interest, etc. Furthermore, games may include various different levels or versions with different degrees of difficulty.

By answering questions correctly in the present embodiment, the child earns money in a pretend bank. The money that the child accumulates in the bank may be saved while accumulating interest at a set interest rate, or the child may choose to spend the money by purchasing simulated items. If the child spends all of the money in the bank, the child must answer more questions correctly in order to win more money. Alternate embodiments may award points rather than money with the goal being to earn the most points. By playing the game according to the present embodiment, children can learn the respective value of coins and bills, as well as saving and spending concepts, enabling parents to encourage their children to learn financial responsibility.

Having fully described at least one embodiment of the present invention, other equivalent or alternative methods of providing a game that teaches monetary skills according to the present invention will be apparent to those skilled in the art. The invention has been described above by way of illustration, and the specific embodiments disclosed are not intended to limit the invention to the particular forms disclosed. For example, the particular implementation of the display means may vary depending upon the particular type of game console used. The game consoles described in the foregoing were directed to handheld implementations; however, similar techniques are to implement non-handheld game consoles that plug into and use a television or computer monitor for a display. Non-handheld implementations of the present invention are contemplated as within the scope of the present invention. The invention is thus to cover all modifications, equivalents, and alternatives falling within the spirit and scope of the following claims.

What is claimed is:

1. An apparatus for a monetary skills game, the apparatus comprising:
a display for presenting animation and video of different coins and bills and their respective values to a child, said display further presenting questions having a monetary theme to said child for teaching monetary information and skills to said child; and
a keypad by which said child responds to said questions where, when said child properly responds to said questions, said child earns money in a pretend bank, accumulating interest at a set interest rate, where said child may choose to spend said money by purchasing simulated items presented on said display, whereby, said child can learn said respective value of coins and bills, as well as saving and spending concepts, enabling parents of said child to encourage their child to learn financial responsibility.

2. The apparatus as recited in claim 1, further comprising a pen slot for holding a pen for use by said child playing the monetary skills game.

3. The apparatus as recited in claim 1, wherein said display and keypad are configured for a hand held device.

4. The apparatus as recited in claim 3, wherein said display is a LCD type display.

5. The apparatus as recited in claim 3, wherein said keypad comprises triangular shaped and rectangular shaped keys for ease of use by said child.

6. The apparatus as recited in claim 5, wherein said triangular shaped buttons are arranged in a pattern to indicate directionality.

7. The apparatus as recited in claim 3, wherein the apparatus is provided in one of a variety of exterior colors with consumer appeal.

8. The apparatus as recited in claim 3, wherein the apparatus is adapted to operate on battery power.

9. The apparatus as recited in claim 1, wherein the apparatus is adapted to operate with touch-screen capabilities.

10. The apparatus as recited in claim 1, wherein the apparatus is adapted to operate with an audio system.

11. The apparatus as recited in claim 1, wherein if the child spends all of the money in the bank, the monetary skills game presents further question on said display, such that said child may answer more questions correctly in order to earn more money.

12. The apparatus as recited in claim 1, wherein where, when said child properly responds to said questions using said keypad, points are awarded, rather than money, with a goal of earning a highest amount points.

13. The apparatus as recited in claim 1, wherein said questions comprise multiple-choice questions.

14. The apparatus as recited in claim 1, wherein said display presents various different levels or versions, of said questions, having different degrees of difficulty.

15. An apparatus for a monetary skills game, the apparatus comprising:
means for presenting animation and video of different coins and bills and their respective values to a child, said presenting means further presenting questions having a monetary theme to said child for teaching monetary information and skills to said child; and
means for said child to respond to said questions where, when said child properly responds to said questions, said child earns money in a pretend bank, accumulating interest at a set interest rate, where said child may choose to spend said money by purchasing simulated items presented on said display, whereby, said child can learn said respective value of coins and bills, as well as saving and spending concepts, enabling parents of said child to encourage their child to learn financial responsibility.
